(19) United States
(12) Patent Application Publication
(10) Pub. No.: US 2026/0284668 A1
(43) Pub. Date: Sep. 24, 2026

(54) LABORATORY HOLDER WITH MARKING

(71) Applicant: INTEGRA BIOSCIENCES AG, Zizers (CH)

(72) Inventors: Manuel IMHOF, Zizers (CH); Noel PASQUIER, Landquart (CH); Rafael STÄDLER, Seewis-Schmitten (CH)

(21) Appl. No.: 19/475,807

(22) PCT Filed: Apr. 16, 2024
(86) PCT No.: PCT/CH2024/050020

§ 371 Date: Oct. 16, 2025

(30) Foreign Application Priority Data
Apr. 19, 2023 (CH) CH000409/2023

(51) Int. Cl. B01L 9/00; G01N 35/00

(52) U.S. Cl. CPC B01L 9/543; G01N 35/00732; B01L 2300/168; G01N 2035/00742; G01N 2035/00811

(57) ABSTRACT

A container for receiving pipette tips and/or fluids for use in a laboratory with a base and at least one side wall. The base or at least one of the side walls has a marking which is applied to the outer surface of the base or the side wall. The marking determines the type of container and its capacity for fluids and/or the type of pipette tips arranged therein. The marking includes a material which causes a shift in the wavelength between the electromagnetic radiation absorbed and emitted by the marking.

### TECHNICAL FIELD OF THE INVENTION

The invention relates to a container for receiving pipetting tips according to the preamble of claim 1 and a receiving device of a laboratory device for receiving a container according to the preamble of claim 19.

### BACKGROUND OF THE INVENTION

When working in the laboratory, containers are used that can serve as fluid containers, for example microtiter plates, or as pipetting tip containers. Despite their different uses, these containers have the same base surface. This allows these containers to be received by the same device. A pipetting unit is usually assigned to the receiving device. During a pipetting process, the device can receive different containers in a specific sequence, wherein, for example, the pipetting unit removes the pipetting tips from a first container, fills the pipetting tips with fluid from a second container (the fluid container), and empties the fluid in the pipetting tips into a third container (the microtiter plate). This achieves a certain degree of automation in the pipetting process. One way to increase the process reliability of automation is through container identification, which can be used to determine the type of container and thus the contents of the containers.

The prior art discloses devices that are capable of automatically identifying a container for receiving pipetting tips. Such devices use an optical sensor in the form of a camera, which captures the container from above. The camera images can be used either to identify a code affixed to the container or to evaluate the pipetting tips depicted therein. The evaluation of the pipetting tips shown allows a statement to be made about the number, filling status, etc. of the pipetting tips.

EP 2 789 389 A1 shows a pipette container which is provided with holes aligned perpendicular to the base surface for receiving pipetting tips. The long narrow side of the pipette container includes a section that is visible from the outside. This section may contain product information that can be easily understood by the user, such as details about the filling volume and the type of pipetting tips.

### Task

It is therefore an objective of the present invention to provide an alternative container for receiving pipetting tips that enables more reliable identification.

### DESCRIPTION

The task is solved with a container for receiving pipetting tips with the features of patent claim 1. The invention relates to a container for receiving pipetting tips for use in a laboratory, with a base and at least one side wall. The base or at least one of the side walls has a marking affixed on the outer surface of the base or side wall. The marking indicates the type of container and its capacity for fluids and/or the type of pipetting tips it holds. The container is characterized in that the marking comprises a material that causes a shift in the wavelengths between the electromagnetic radiation absorbed and emitted by the marking.

Due to the material that causes the shift in the wavelengths between the absorbed and emitted electromagnetic radiation, the marking can emit radiation with different wavelengths. To do this, the marking must be irradiated with two electromagnetic waves, which ideally already have different wavelengths. Preferably, one of these electromagnetic radiations lies in the visible range, while the other electromagnetic radiation is preferably not visible to the human eye. The goal is to identify the marking based on the radiation it emits and, in particular, the resulting shift in the wavelengths of this radiation. The type of container can be identified by recognizing the marking.

The container is designed to receive pipetting tips. The marking contains information about what the respective container can receive. In addition, additional information about the pipetting tips arranged in the container may be included in the marking.

The container is intended for use in laboratories and should preferably only be used in sterile environments. The material of the container should therefore be suitable for use in a sterile environment. The container according to the invention preferably comprises a plastic, in particular polypropylene, polycarbonate, polystyrene, or cycloolefin copolymers.

The difference in wavelength between the electromagnetic radiation absorbed and emitted by the marking is preferably at least 20 nm. The shift in the wavelengths of at least 20 nm enables reliable identification of the shift in the wavelengths.

Preferably, the electromagnetic radiation absorbed by the marking has a wavelength of 100 nm to 3000 nm. This range covers radiation from infrared to ultraviolet, which can be generated cost-effectively.

In a preferred embodiment, the marking comprises a fluorescent material which causes the shift in the wavelengths of the emitted radiation. The use of fluorescent material fulfills the condition for marking the subject matter of the invention that a shift in the wavelengths occurs between the absorbed and emitted radiation. At the same time, the fluorescent material is relatively easy to obtain and can be manufactured cost-effectively.

In another preferred embodiment, the marking is arranged on the base of the container. The base of the container has a surface whose size and shape preferably does not vary from container type to container type. This means that the marking can be placed in the same location for all containers. This facilitates the production of the containers and affixing of the marking, as well as the reading of the information from the marking. As a rule, the base of the container rests on a receiving surface. Affixing the marking on the base of the container has the added advantage of minimizing the distance between a sensor device and the marking, which in turn increases process reliability when reading the information from the marking.

The marking is advantageously located in the center at the base of the container. Placing the marking in the center allows the container to be rotated around its vertical axis, depending on the base surface of the container. With a rectangular base surface, the central arrangement of the marking allows the container to be rotated 180° in a receiving device without affecting the reading function of the receiving function. With a square base surface, the container can be rotated 90° around its vertical axis.

The container preferably has a rectangular layout. The rectangular layout refers to the presence of two parallel long sides and two parallel short sides, wherein the ratio of the long sides to the short sides is not 1:1, unlike a square layout. The rectangular layout of the container can have rounded corners, for example.

In an alternative embodiment to the previous one, the marking is located on a side wall of the container. The side wall is visible when the container is resting on its base. Affixing the marking on a side wall therefore offers the advantage that the marking on the container is immediately visible to a laboratory worker, who is thus able to assess the suitability of the respective container in advance.

In another preferred embodiment, the marking comprises at least two materials, each of which causes a different shift in the wavelengths between the radiation absorbed and emitted by the marking. The shift in the wavelengths between the absorbed and emitted radiation serves as information carrier for the marking, which can be used to identify the respective container type by comparing it with stored information. The use of more than two materials, each causing different shifts in the wavelengths, increases the information content of the marking.

Advantageously, the marking has an axially symmetrical surface. A symmetrical surface facilitates the reading of information from the marking by a sensor device. At the same time, the maximum extension of the marking in both directions perpendicular to the axis of symmetry is equal, which better defines the surface to be detected by the sensor device.

The marking preferably has a point-symmetrical surface. The point-symmetrical surface allows the sensor device to be rotated 180°. If the marking on the base of the container is centered, the point-symmetrical surface of the marking allows the container to be rotated 180° on a receiving device as desired.

Even better, the marking should have a circular or square surface. Affixing a circular or square surface is simple in terms of manufacturing and, due to the many symmetries of these surfaces, offers a high degree of freedom for positioning the container on a receiving device.

In a preferred embodiment, the marking comprises two or more surfaces. The marking can be composed of several surfaces. These surfaces may be in contact with each other or may be spaced apart. It is also possible that the surfaces are arranged symmetrically to each other.

Preferably, the first surface is located in the center of the marking, and the other surfaces each form a frame surface that completely surrounds the first surface. This creates a clear structure from the center of the marking outwards. The surfaces do not need to be in contact with each other.

Each surface preferably comprises a material that causes a different shift in the wavelengths between the electromagnetic radiation absorbed and emitted by the marking. This means that more than one surface and more than one material are intended for marking. The clear allocation that each surface comprises a material that causes a different shift in the wavelengths facilitates affixing of the marking on the container and its inspection.

The container advantageously has dimensions that comply with the ANSI standard according to the SBS format (Society for Biomolecular Screening). The SBS format according to the ANSI standard defines, among other things, the size of containers used for specific laboratory work. The ANSI standard leads to standardization of container dimensions, which facilitates the interchangeability of laboratory equipment. The SBS format specifies a length of approximately 127 mm and a width of approximately 85 mm for the container dimensions. Therefore, the container preferably has a length of 120 to 130 mm and a width of 80 to 90 mm.

The marking on the container is designed to be detected by a sensor device. The sensor device should be able to read all the information contained in the marking. This requires a minimum size for the marking surface. Preferably, the shortest extension of the marking should be at least 10 mm.

In a further aspect, the invention relates to a receiving device of a pipetting device for receiving a container. The receiving device comprises a receiving surface on which the container comes to rest, and a frame which forms the rim of the receiving surface and protrudes perpendicularly from the receiving surface. A sensor device is arranged in the receiving surface, which has a radiation detector and two radiation sources, wherein the two radiation sources emit electromagnetic rays with different wavelengths and the radiation detector detects the wavelength of the received electromagnetic radiation.

The frame has the task of placing a container with a marking in the receiving device in such a way that the sensor device of the receiving device can read the information from the marking on the container. The receiving device records the container in such a way that the distance between the sensor device of the receiving device and the marking on the container cannot vary greatly. This is achieved, for example, by ensuring that the distance between the opposite inner surfaces of the frame is slightly greater than the maximum extension of the container in the longitudinal or transverse direction. Minimally larger here means that the container can be inserted into the receiving device without resistance or friction. At the same time, the distance between the container and the frame should be so small that the container can perform almost no lateral movement and is thus completely restricted in its sideways movement. As a result, the marking on the container is always close to the sensor device of the receiving device.

Preferably, the sensor device has a connection to a data storage device in which a database with reference measurement data is stored, wherein the reference measurement data shows the assignment of container types to wavelength combinations. The database containing the stored reference data makes it possible to assign the measured container to its type. To do this, it is sufficient to compare the measured and stored wavelength combinations.

In a preferred embodiment, the sensor device has a maximum distance of 30 mm, in particular 20 mm, from the center of the receiving surface. The center of the receiving surface is formed by its center point. In the case of a rectangular surface, this is defined by the intersection of the two diagonals. It is advisable to place the marking as centrally as possible on the container. This makes it possible to read the information from the marking using a centrally located sensor device, regardless of how the container is rotated around the vertical axis. Ideally, the sensor device is located within the surface created by the perpendicular projection of the marking on the container onto the receiving surface.

The sensor device is preferably located in the center of the receiving surface. The central arrangement of the sensor device allows information to be read from the marking as long as the marking is also centrally located on the container. The container can be inserted into the receiving device in any position for this purpose.

Advantageously, the first radiation source is designed to emit electromagnetic radiation with a wavelength of 380 nm to 780 nm, and the second radiation source is designed to emit electromagnetic radiation with a different wavelength of 10 nm to 410 nm or 750 nm to 3000 nm. This means that radiation in the visible range and radiation in the invisible range can be used. When a material is irradiated with rays in the non-visible range, wherein the rays emitted by the material have a different wavelength to the absorbed rays, the radiation emitted by this material may be in the visible range.

In a preferred embodiment, the receiving device has a protective device for the sensor device. The protective device prevents dirt or other particles from reaching the sensor device and affecting the measurement accuracy.

The protective device is preferably located above the sensor device. Since the sensor device is located in the receiving surface, the likelihood of contamination from the side of the receiving surface is greater. A protective device above the sensor device can protect it from such contamination.

Advantageously, the protective device comprises a material that is transparent to electromagnetic radiation. This ensures that the electromagnetic rays from the sensor device always pass through the protective device and strike an object placed in the receiving device.

Preferably, the receiving surface has a perforation, and the sensor device is arranged in the perforation. The perforation offers a relatively simple manufacturing option. If the receiving surface is part of a storage station that provides a thin plate to form the receiving surface, a perforation can be created with little effort to receive the sensor device.

The protective device advantageously seals the perforation. The protective device thus prevents fluid or other particles from reaching the sensor device from outside. Since the receiving device is intended for use in a laboratory, there is a risk that fluid may spill from a container and cover at least parts of the surface of the laboratory equipment.

The optional features mentioned can be implemented in any combination, provided they are not mutually exclusive. In particular, where preferred ranges are specified, further preferred ranges result from combinations of the minimum and maximum values specified in the ranges.

### BRIEF DESCRIPTION OF THE FIGURES

Exemplary embodiments of the invention are described below with reference to the figures. Shown in a non-scale, schematic representation is:

FIG. 1: A perspective view of a device with a pipetting unit and three containers according to the invention for performing a pipetting operation;

FIG. 2: A three-dimensional view of a container according to the invention for receiving fluid, from below;

FIG. 3: A perspective view of a section of a storage surface with only one receiving device;

FIG. 4: A perspective view of a longitudinal section through the receiving device from FIG. 3;

FIG. 5: A three-dimensional view of a container according to the invention for receiving pipetting tips, from below;

FIG. 6: A three-dimensional view of a container according to the invention in the form of a microtiter plate.

### DETAILED DESCRIPTION OF THE FIGURES

In the following, identical reference numbers refer to identical elements or elements with identical functions (in different figures). An additional apostrophe can be used to distinguish between similar elements or elements with the same or similar functions in a further version.

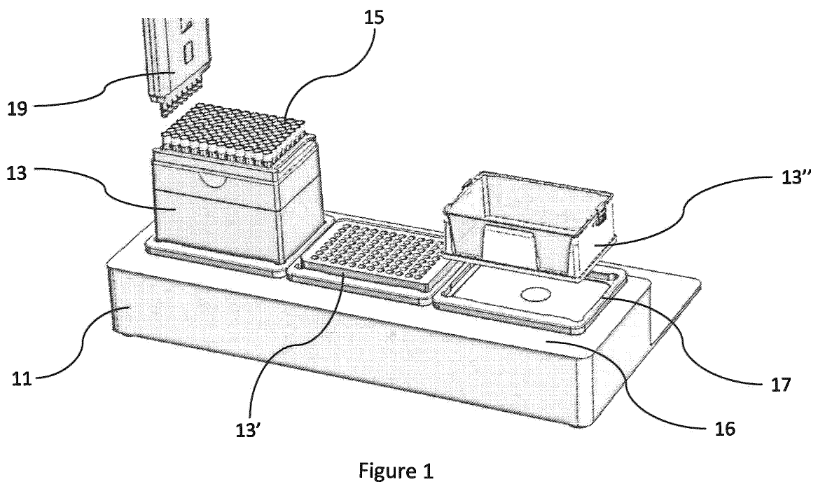

FIG. 1 shows a storage station 11 for storing or receiving containers 13, wherein the containers 13 are intended for use in a laboratory and for receiving pipetting tips 15 and/or fluids. The top side of the storage station 11 is formed by a storage surface 16, which in turn has receiving devices 17. Two containers 13, 13′ are arranged on the storage surface 16, each in a receiving device 17, with a third container 13″ shown above the receiving device 17 assigned to it. A pipetting unit 19 is arranged above the storage station 11. The pipetting unit 19 is capable of receiving pipetting tips 15, filling these pipetting tips 15 with a fluid from a fluid container 13″ and emptying them into a container 13″, which may be designed as a microtiter plate. The pipetting unit 19 can be connected to the storage station 11 in such a way that information can be exchanged between the two components. In an alternative embodiment, the storage surface 16 may also have only one receiving device 17, in which only one container 13 can be placed at a time. In such a design, the containers for receiving pipetting tips and/or fluids would be arranged one after the other in the receiving device 17.

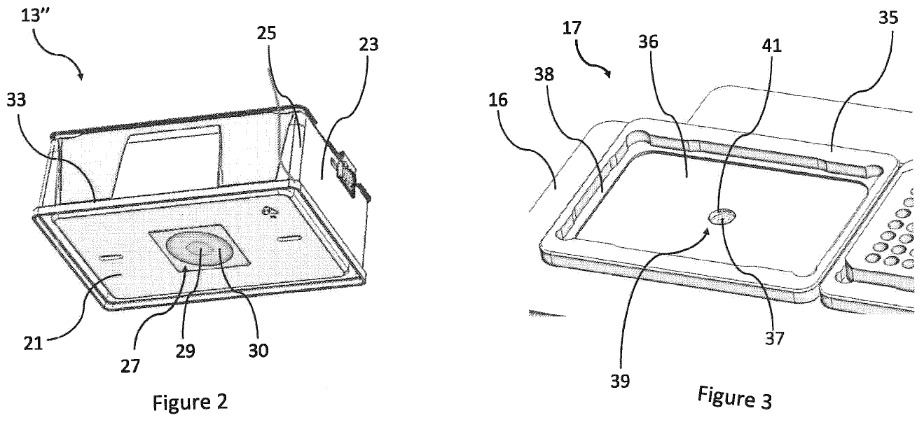

FIG. 2 shows a container 13 from below. The container 13 shown comprises a rectangular base 21 with rounded corners 25. The width of the base surface is about half the length. Side walls 23 extend perpendicularly from the rim of the base. The height of the side walls 23 is again approximately half the width of the base surface. Two adjacent side walls 23 are connected to each other via a rounded edge. The rounded edge has the same curvature as rounded corner 25, from which the edge protrudes. A marking 27 is affixed to the underside of the base 21. The shape of the marking 27 is designed as a circle, wherein the circle is formed from an inner circle 29 and an annular surface 30 adjacent to the inner circle. Marking 27 is located in the center of the base surface so that the center point of the circle of marking 27 lies at the intersection of the diagonals of the base surface. In the version shown, the diameter of the circle of the marking 27 is approximately twice that of the inner circle 29.

The side walls 23 of the container shown in FIG. 2, which extend approximately perpendicular to the base surface, each have a rim at their upper edges. The container may have a multi-part structure, in that the container consists of a reservoir for receiving the fluid and a base element. The base element serves to receive the reservoir and form a seat for placing the container 13 in the receiving device 17. The side wall 23 has a gradation 33 on its lower edge toward the outside. Thus, the gradation at the lower edge forms the greatest extension of the container in the longitudinal and transverse directions.

FIG. 3 shows a section of the storage surface 16 with a receiving device 17. The receiving device 17 is formed by placing a frame 35 on the storage surface 16. The area of the storage surface 16 enclosed by frame 35 forms the receiving surface 36 on which the container 13 comes to rest. The receiving surface 36 is approximately the same size as the base surface 21 of a container 13, including the gradations 33. The frame 35 surrounds the receiving surface 36 so that a container 13 can be inserted into the receiving device 17 and removed from it in a direction perpendicular to the receiving surface 36. The inner contour of frame 35 is adapted to correspond to the outer contour of container 13. This means that if the outer contour of container 13 has rounded edges, cylindrical recesses are provided at the corners of the inner contour of the frame, which have a smaller radius than the rounded edges of the container. Alternatively, the frame 35 is formed by a raised rim on the receiving surface 36. In the version shown, the receiving surface 36 is formed by two surfaces. The frame 35 has an inward extension at the inner lower edge, forming a gradation. The top side of the gradation forms a support surface 38, which forms a first region of the receiving surface. The second region of the receiving surface is formed by the part of the storage surface 16 which is bounded by the frame 35 with the gradation 38. Thus, the receiving surface 16 can consist of a region of the storage surface and a support surface 38 surrounding this region. A perforation 37 is provided in the center of the receiving surface 36, which is cylindrical in the simplest design shown. The cylinder axis of the perforation 37, which is arranged perpendicular to the receiving surface 36, is located in the center of the receiving surface 36. The center of the receiving surface 36 can be formed by the intersection of the two diagonals. A sensor device 39 is arranged in or below the perforation 37. The sensor device 39 comprises an optical detector and a light beam source, which is directed toward the receiving surface 36. A protective device 41 is provided above the sensor device 39. The version shown here is made of glass, but it can also be made of another material that is transparent to the rays of the sensor device. The glass 41 is flush with the receiving surface 36.

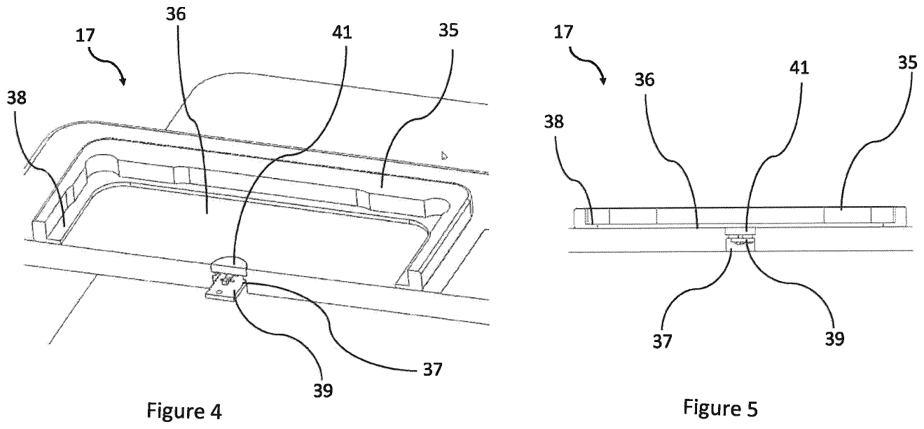

FIG. 4 shows a perspective view of the receiving device 17 from FIG. 3, cut in the longitudinal direction. The storage station 11 has a cavity inside it. For this reason, the top side of the storage station is formed by a wall with a certain wall thickness. The sensor device 39 is arranged in the perforation 37 through the wall of the storage station. In the embodiment shown, the perforation 37 has a gradation on which the protective device 41 is placed, wherein the distance between the gradation and the receiving surface 36 is selected such that the top side of the protective device is flush with the receiving surface 36.

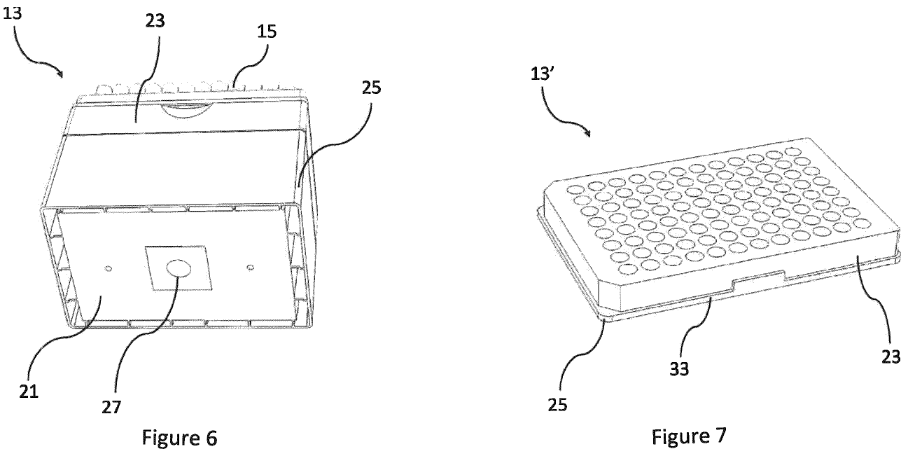

FIGS. 5 and 6 show further possible embodiments of a container 13 according to the invention. A container 13 for receiving pipetting tips is shown in FIG. 5. The container has a rectangular base surface with rounded corners 25. The four side walls extend perpendicularly from the base surface of the container and are of equal height. The holder for receiving the pipetting tips inside the container can be designed as desired. There is a marking in the middle of the base. The marking covers a circular surface. For example, the marking contains information that the container is suitable for receiving pipetting tips and, optionally, the size of the pipetting tips in that container. The information is contained in the marking as a code. The content of the information is determined by comparing the measured code with previously stored codes.

FIG. 6 shows a microtiter plate as another possible embodiment of a container 13 according to the invention. It has a marking on its base surface that is not visible from the perspective shown in FIG. 7. The microtiter plate has a base surface rim formed by a rectangle with rounded corners 25. The microtiter plate forms a container for receiving fluids. For this purpose, the microtiter plate has wells that are isolated from each other and arranged evenly in rows and columns.

### Further Exemplary Embodiment

In a preferred embodiment, the material of the marking on the container comprises fluorescent material.

The same beneficial effect can also be achieved if, instead of a fluorescent material, the marking on the container comprises a material that triggers high photon conversion. This allows the marking to emit electromagnetic radiation in the visible range when irradiated with electromagnetic radiation in the infrared range. Instead of a positive Stokes shift as in fluorescence, such applications make use of a negative Stokes shift, whereby the wavelengths of the electromagnetic radiation emitted by the marking are shorter than those absorbed by it.

In the context of the present invention, a “material that causes a shift in the wavelengths between the electromagnetic radiation absorbed and emitted by the marking” refers to organic or inorganic molecules or elements that exhibit this property. Organic molecules that can cause high photon conversion are typically polycyclic aromatic hydrocarbons (PAHs). Inorganic materials that can cause high photon conversion are mainly ions of those elements that are located in the d or f block of the periodic table of elements. For a non-exhaustive list of such ions, examples include Ln³⁺, Ti²⁺, Ni²⁺, Mo³⁺, Re⁴⁺, and Os⁴⁺. These molecules can be integrated into the marking. This is achieved when the molecules or elements are mixed into the plastic material during production, for example in the extruder. Alternatively, the molecules can be incorporated into a matrix and applied as a coating or film.

While specific embodiments have been described above, it is obvious that different combinations of the embodiments shown can be used, insofar as the embodiments are not mutually exclusive.

While the invention has been described above with reference to specific embodiments, it is obvious that changes, modifications, variations, and combinations can be made without departing from the spirit of the invention.

### REFERENCE LIST

11 Storage station for containers
13 Container
15 Pipetting tips
16 Storage surface
17 Receiving device
19 Pipetting unit
21 Base of the container
23 Side wall of the container
25 Corners of the container
27 Marking
29 Inner circle of the marking
30 Annular surface of the marking
31 Gap between side walls
33 Gradation of the side wall of the container
35 Frame of the receiving device
36 Receiving surface
37 Perforation in the receiving surface
38 Support surface
39 Sensor device
41 Protective device

1.-28. (canceled)

29. A container for receiving pipetting tips for use in a laboratory, comprising a base having an outer surface and at least one side wall, wherein the base or at least one side wall has a marking which is affixed to the outer surface of the base or the at least one side wall, wherein the marking indicates the type of pipetting tips arranged therein, and wherein the marking comprises a material which causes a shift in the wavelengths between the electromagnetic radiation absorbed and emitted by the marking.

30. The container according to claim 29, wherein the difference in wavelength between the electromagnetic radiation absorbed and emitted by the marking is at least 20 nm.

31. The container according to claim 29, wherein the electromagnetic radiation absorbed by the marking has a wavelength of a 100 nm to 3000 nm.

32. The container according to claim 29, wherein the marking comprises a fluorescent material which causes the shift in the wavelengths of the radiation emitted.

33. The container according to claim 29, wherein the marking is arranged on the base of the container.

34. The container according to claim 33, wherein the marking is disposed at a center of the base of the container.

35. The container according to claim 29, wherein the marking is arranged on the at least one side wall of the container.

36. The container according to claim 29, wherein the marking comprises at least two materials, each of which causes a different shift in the wavelengths between the electromagnetic radiation absorbed and emitted by the marking.

37. The container according to claim 29, wherein the marking has at least one of an axially symmetrical surface or a point-symmetrical surface.

38. The container according to claim 29, wherein a shape of the marking is one of circular or square.

39. The container according to claim 29, wherein the marking comprises at least two surfaces.

40. The container according to claim 39, wherein a first surface is disposed in a center of the marking and a second surface forms a frame surface completely surrounding the first surface.

41. The container according to claim 39, wherein each surface of the at least two surfaces comprises a material that causes a different shift in the wavelengths between the electromagnetic radiation absorbed and emitted by the marking.

42. The container according to claim 29, wherein the container has a length of 120 to 130 mm and a width of 80 to 90 mm, in particular complying with the ANSI standard according to the SBS format (Society for Biomolecular Screening).

43. The container according to claim 29, wherein a shortest length of the marking is at least 10 mm.

44. A receiving device of a pipetting device for receiving a container, comprising:
a receiving surface on which the container is disposed, and a frame which forms a rim of the receiving surface and protrudes perpendicularly from the receiving surface,
wherein
a sensor device arranged in the receiving surface, which has a radiation detector and first and second radiation sources, wherein the first and second radiation sources emit electromagnetic rays with different wavelengths and the radiation detector detects the wavelength of the received electromagnetic radiation.

45. The receiving device according to claim 44, wherein the sensor device has a connection to a data storage device in which a database with reference measurement data is stored, wherein the reference measurement data comprises the assignment of container types to wavelength combinations.

46. The receiving device according to claim 44, wherein the sensor device is disposed in a center of the receiving surface.

47. The receiving device according to claim 44, wherein the first radiation source emits electromagnetic radiation with a wavelength of 380 nm to 780 nm and the second radiation source emits electromagnetic radiation with a different wavelength of 10 nm to 410 nm or 750 nm to 3000 nm.

48. The receiving device according to claim 44, wherein the receiving surface has a perforation and the sensor device is arranged in the perforation.
